(19) United States
(12) Patent Application Publication
(10) Pub. No.: US 2026/0009272 A1
(43) Pub. Date: Jan. 8, 2026

(54) DOOR CHECKER ASSEMBLY FOR VEHICLE

(71) Applicants: Hyundai Motor Company, Seoul (KR); Kia Corporation, Seoul (KR); ILJIN Co., Ltd., Gyeongju-si (KR)

(72) Inventors: Gi Ho Kwon, Hwaseong-si (KR); Heung Tae Kim, Seoul (KR); Jeong Rae Lee, Seoul (KR); Jun Yong Seo, Seoul (KR)

(21) Appl. No.: 19/214,921

(22) Filed: May 21, 2025

(30) Foreign Application Priority Data
May 23, 2024 (KR) 10-2024-0066880

(51) Int. Cl. E05F 5/08

(52) U.S. Cl. CPC E05F 5/08; E05Y 2201/474; E05Y 2900/531

(57) ABSTRACT

A door checker assembly can be implemented for a vehicle. The assembly includes a vehicle body mounting part configured to be mounted on a vehicle body of the vehicle, a door mounting part configured to be mounted on a door of the vehicle, a checker arm configured to pass through the vehicle body mounting part and be movable relative to the vehicle body mounting part, and a locking latch mounted on the door mounting part to be slidably movable between a latch position at which the locking latch is coupled to the checker arm and a release position at which the locking latch is decoupled from the checker arm.

### CROSS REFERENCE TO RELATED APPLICATIONS

The present application claims priority to Korean Patent Application No. 10-2024-0066880, filed May 23, 2024, the entire contents of which is incorporated herein for all purposes by this reference.

### TECHNICAL FIELD

The present disclosure relates to a door checker assembly for a vehicle.

### BACKGROUND

A door checker assembly is mounted to a door of a vehicle to assist in the opening

and closing of the door. For example, the door checker assembly may be installed between a vehicle body and a door of the vehicle, and may be configured to limit the maximum opening angle of the door and to maintain the state of the door opened at a predetermined angle.

Such door checker assemblies commonly restrict a door from being opened at a

predetermined maximum opening angle or more, but there are also door checker assemblies configured to allow a door to be opened beyond a predetermined maximum opening angle when desired by a user.

For example, FIG. 1 illustrates an example of a conventional door checker assembly 1. As shown in FIG. 1, a checker arm 2 may be configured to be coupled to a door mounting part 3 by a pin 4. When a user intends to open a door at a predetermined maximum opening angle or more, the user may manually remove the pin 4 from both the door mounting part 3 and the checker arm 2 to further open the door.

However, this structure causes considerable inconvenience or difficulty for a user when closing the door after opening the door, as the user must align a pin hole of the door mounting part 3 with the pin hole of the checker arm 2 and simultaneously insert the pin 4 into the aligned pin holes.

In addition, when removing the pin 4 from the door mounting part 3 and the checker arm 2, a user also experiences considerable inconvenience due to resistance caused by dimensional tolerances between the pin and the pin holes.

### SUMMARY

The present disclosure relates to a door checker assembly mounted on a door of a vehicle to assist in the opening and closing of the door and, more particularly, to a door checker assembly for a vehicle having a locking latch that allows a door of a vehicle to be selectively opened beyond a predetermined opening angle at any time as needed.

The present disclosure has been devised to solve the above-described problems, and embodiments of the present disclosure can provide a door checker assembly for a vehicle with improved convenience in the coupling and decoupling operations of a pin, compared to a conventional door checker assembly for a vehicle.

In addition, the present disclosure aims to provide a door checker assembly for a vehicle that allows a user to perform a pin decoupling operation at any desired time, even if the door of the vehicle has not reached a predetermined maximum opening angle.

In addition, the present disclosure aims to provide a door checker assembly for a vehicle in which a checker arm can be reliably coupled to a locking latch when the checker arm is decoupled from the locking latch and then recoupled thereto.

According to an embodiment of the present disclosure, a door checker assembly for a vehicle can be mounted between a vehicle body and a door to assist in opening and closing operations of the door. A vehicle body mounting part is configured to be mounted on the vehicle body. A door mounting part is configured to be mounted on the door. A checker arm is configured to pass through the vehicle body mounting part and be movable relative to the vehicle body mounting part 200. A locking latch is mounted on the door mounting part to be slidably movable between a latch position at which the locking latch is coupled to the checker arm and a release position at which the locking latch is decoupled from the checker arm.

In addition, the checker arm may include a pin on a door-side end portion thereof, on the basis of the locking latch being located at the latch position. A latch protrusion part of the locking latch may be configured to restrain the pin of the checker arm so that the pin of the checker arm is coupled to the locking latch. On the basis of the locking latch being located at the release position, the latch protrusion part of the locking latch may be configured so as not to restrain the pin of the checker arm so that the pin of the checker arm 300 is decoupled from the locking latch.

According to an embodiment of the present disclosure, the latch protrusion part of the locking latch may include a holding part extending in a door-side direction, wherein the holding part may restrain the pin of the checker arm.

In addition, according to an embodiment of the present disclosure, the door mounting part may include a housing configured to at least partially surround the locking latch and a biasing member disposed inside the housing and configured to bias the locking latch 400 in one direction so that the locking latch is located at the latch position on the basis of the locking latch not being subjected to an external force.

According to an embodiment of the present disclosure, the biasing member may be a coil spring that may be arranged such that a first end of the coil spring is in contact with an inner surface of the housing and a second end of the coil spring is in contact with an outer surface of the locking latch.

In addition, the housing may include through holes extending in the same direction as a sliding movement direction of the locking latch. The locking latch may include protruding parts configured to extend through the through holes, and on the basis of the locking latch moving slidably between the latch position and the release position, movements of the protruding parts in the through holes may be guided, so that the movement of the locking latch may be guided.

According to an embodiment of the present disclosure, the housing may include housing coupling recesses formed in arc shapes so that each of the housing coupling recesses surrounds at least a portion of an outer circumferential surface of a pin of the checker arm. The housing may include a first housing protrusion part having a first guide surface extending from a first end of the housing coupling recess, and a second housing protrusion part having a second guide surface extending from a second end of the housing coupling recess. On the basis of the checker arm being decoupled from and then recoupled to the locking latch, the pin of the checker arm may be guided into the housing coupling recess along the first guide surface or the second guide surface.

The first guide surface may be configured to extend from the first end of the housing coupling recess in a vehicle inward direction and a vehicle body-side direction, and the second guide surface may be configured to extend from the second end of the housing coupling recess in a vehicle outward direction and a vehicle body-side direction.

According to an embodiment of the present disclosure, the holding part may move in a vehicle inward direction and a vehicle outward direction between the latch position and the release position, so that on the basis of the locking latch being located at the latch position, the holding part may be arranged further inside the vehicle than a center of the pin 330 of the checker arm. On the basis of the locking latch being located at the release position, the holding part may be arranged further outside the vehicle than the center of the pin of the checker arm.

According to another embodiment of the present disclosure, the holding part may move in the door-side direction and a vehicle body-side direction between the latch position and the release position, so that the holding part may be arranged closer to a vehicle body side when the locking latch is located at the release position than when the locking latch is located at the latch position.

According to an embodiment of the present disclosure, the locking latch may have a lever formed on a first end thereof and a bar formed on an end opposite to the first end on which the lever is formed, and the housing may have a recess that restricts a rotation of the bar, so that when the locking latch slides due to an external force applied through the lever, an unintended rotation of the locking latch may be prevented.

In addition, the recess may be formed to continuously engage with a coupling surface of the bar that faces in a vehicle body-side direction during movement of the bar.

Alternatively, the recess may be formed to continuously engage with a coupling surface of the bar that faces in a vehicle outward direction during movement of the bar.

According to an embodiment of the present disclosure, through the structure of the sliding-type locking latch, the convenience of coupling and decoupling the pin of the checker arm can be improved, compared to a conventional door checker assembly for a vehicle.

In addition, according to an embodiment of the present disclosure, regardless of the opening angle of the door, there is an advantage in that a user is capable of performing the decoupling operation of the pin at any desired time, for example, even before the vehicle door reaches a predetermined maximum opening angle.

In addition, according to an embodiment of the present disclosure, when the checker arm is decoupled from the locking latch by operating the lever, unintended rotation of the locking latch can be prevented, and when the checker arm is recoupled to the locking latch after being decoupled therefrom, the checker arm can be stably guided into and coupled to the coupling recess of the locking latch, thereby further improving the operation convenience of a user.

### BRIEF DESCRIPTION OF THE DRAWINGS

FIG. 1 illustrates an example of a conventional door checker assembly for a vehicle.

FIG. 2 is a view illustrating the opening and closing of a door of a vehicle in which a door checker assembly according to an embodiment of the present disclosure is installed.

FIG. 3 illustrates the door checker assembly for a vehicle in a state in which the door is closed, according to an embodiment of the present disclosure.

FIG. 4 illustrates the door checker assembly for a vehicle in a state which the door is opened at a maximum opening angle thereof, according to an embodiment of the present disclosure.

FIG. 5 illustrates the door checker assembly for a vehicle in a state in which the door is opened at the maximum opening angle thereof or more, according to an embodiment of the present disclosure.

FIG. 6 illustrates a checker arm according to an embodiment of the present disclosure.

FIG. 7 is a view illustrating the coupling of the checker arm and a pin according to an embodiment of the present disclosure.

FIG. 8 is a partial perspective view of the door checker assembly for a vehicle according to an embodiment of the present disclosure.

FIG. 9 is an exploded perspective view of a housing and components coupled inside the housing in the door checker assembly for a vehicle according to an embodiment of the present disclosure.

FIG. 10 illustrates a state in which the pin of the checker arm is coupled to a locking latch according to an embodiment of the present disclosure.

FIG. 11 illustrates a state in which the pin of the checker arm is separable from the locking latch according to an embodiment of the present disclosure.

FIG. 12 illustrates a rotational departure prevention structure of the door checker assembly for a vehicle according to an embodiment of the present disclosure.

FIG. 13 illustrates a state in which the pin of the checker arm is coupled to the locking latch in the door checker assembly for a vehicle according to another embodiment of the present disclosure.

FIG. 14 illustrates a state in which the pin of the checker arm is separable from the locking latch in the door checker assembly for a vehicle according to another embodiment of the present disclosure.

FIG. 15 illustrates a rotational departure prevention structure of the door checker assembly for a vehicle according to another embodiment of the present disclosure.

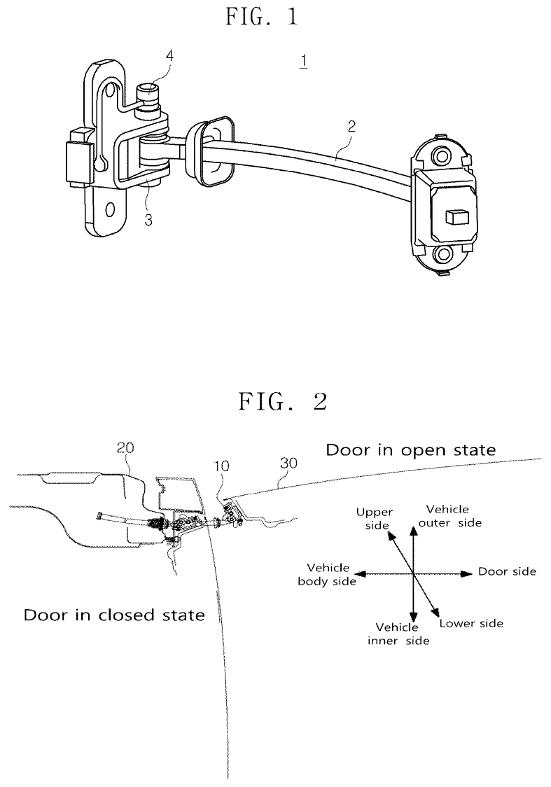

### DETAILED DESCRIPTION

Hereinafter, preferred embodiments of the present disclosure will be described in detail with reference to the attached drawings.

In order to clearly explain the present disclosure, specific descriptions of parts unrelated to the present disclosure are omitted, and the same reference numerals are used to describe the same components throughout the specification. In addition, the shape and size of each component illustrated in the drawings are arbitrarily illustrated for convenience of explanation, and therefore the present disclosure is not necessarily limited to the illustrated shape and size. That is, it should be understood that specific shapes, structures, and characteristics described in the specification may be modified and implemented from one embodiment to another without departing from the spirit and scope of the present disclosure, and that the positions or arrangements of individual components may also be changed without departing from the spirit and scope of the present disclosure. Therefore, the detailed description set forth below is not intended to be limiting, and the scope of the present disclosure should be accepted as encompassing the scope claimed in the claims of the patent and all scopes equivalent thereto.

Expressions such as “including,” “being provided with,” “having,” and the like, as used in the present disclosure, are to be understood as open-ended terms implying the possibility of including other embodiments, unless otherwise indicated in the phrase or sentence in which the expression is included.

Singular forms described in the present disclosure may include plural meanings unless otherwise stated, and the same applies to the singular forms described in the claims.

Expressions “first,” “second,” etc. used in the present disclosure are used to distinguish between a plurality of components and do not limit the order or importance of the components.

In all components constituting a door checker assembly for a vehicle of the present disclosure, a direction toward a door is referred to as “a door side,” and a direction toward a vehicle body is referred to as “a vehicle body side.” For example, a door mounting part of the door checker assembly for a vehicle of the present disclosure may include mounting flanges mounted on the door, and a direction in which each of the mounting flanges is installed may correspond to the door side, or the opposite direction may correspond to the vehicle body side.

In addition, in all components constituting the door checker assembly for a vehicle of the present disclosure, a direction toward the vehicle as a direction perpendicular to a door-side direction and a vehicle body-side direction is referred to as a “vehicle inward direction,” and the opposite direction, that is, the direction away from the vehicle, is referred to as a “vehicle outward direction.”

In the present disclosure, since the orientation of the door checker assembly for a vehicle changes as the door is opened, the aforementioned door-side direction, vehicle body-side direction, vehicle interior side, and vehicle exterior side should not be understood as fixed directions, but as directions that vary depending on the change of the orientation of the door checker assembly.

In addition, the directional terms such as “upward” and “upper,” as well as “downward” and “lower,” used to describe the door checker assembly for a vehicle of the present disclosure, are defined on the basis of the extension directions of the pivot shaft of the hinge by which the door is pivotally connected to the vehicle body. That is, one direction of the extension directions of the pivot shaft corresponds to “upward” or “upper,” and the opposite direction corresponds to “downward” or “lower.”

FIG. 2 is a view illustrating the opening and closing of a door of a vehicle in which a door checker assembly according to an embodiment of the present disclosure is installed.

As illustrated in FIG. 2, a door checker assembly 10 according to an embodiment of the present disclosure may be applied to the door 30 (for example, a trunk door) installed on the rear portion of the vehicle. Such a door 30 may be installed in a double-door configuration as shown in FIG. 2.

The door 30 is pivotably coupled to the vehicle body 20 by one or more hinges (installed separately from the door checker assembly) (not shown). The door checker assembly 10 may be mounted between the vehicle body 20 and the door 30, independently of the hinges, and may be configured to limit the maximum opening angle of the door 30 and to maintain the door 30 in an open state at a predetermined angle. FIG. 2 illustrates both the closed state of the door 30 and the opened state thereof at the maximum opening angle (e.g., 95°) in a single drawing (for purposes of understanding).

However, especially in the case of a trunk door, a user may sometimes need to open the door 30 at the maximum opening angle or more, for example, for the purpose of loading luggage. According to an embodiment of the present disclosure, the door checker assembly 10 for a vehicle is configured to allow the door 30 to be opened beyond a predetermined maximum opening angle when desired by the user.

According to an embodiment of the present disclosure, the door checker assembly 10 for a vehicle may include: a door mounting part 100 configured to be mounted on the door 30; a vehicle body mounting part 200 configured to be mounted on the vehicle body 20; a checker arm 300 configured to pass through the vehicle body mounting part 200 and be movable relative to the vehicle body mounting part 200; and a locking latch 400 mounted on the door mounting part 100 to be slidably movable between a latch position at which the locking latch 400 is coupled to the checker arm 300 and a release position at which the locking latch 400 is decoupled from the checker arm 300.

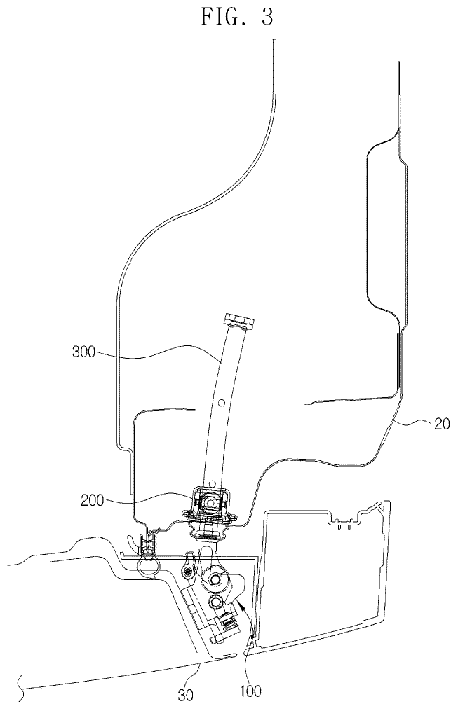

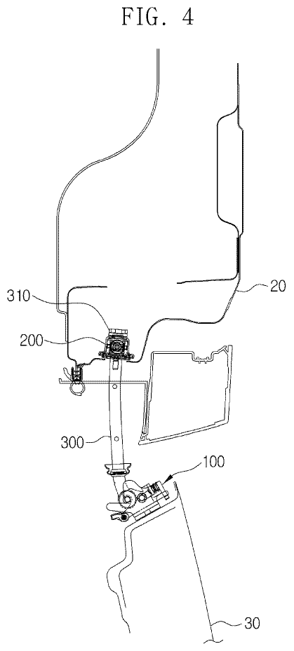

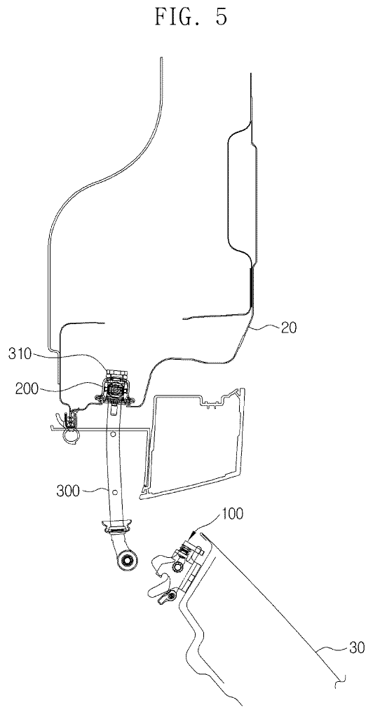

FIG. 3 illustrates the door checker assembly for a vehicle in a state in which the door is closed, according to an embodiment of the present disclosure, FIG. 4 illustrates the door checker assembly for a vehicle in a state which the door is opened at a maximum opening angle thereof, according to an embodiment of the present disclosure, and FIG. 5 illustrates the door checker assembly for a vehicle in a state in which the door is opened at the maximum opening angle thereof or more, according to an embodiment of the present disclosure.

As illustrated in FIGS. 3 and 4, according to the door checker assembly 10 for a vehicle, as the door 30 is opened from the closed state thereof, the checker arm 300 moves in a sliding manner relative to the vehicle body mounting part 200 by passing through the vehicle body mounting part 200, and when a stopper 310 installed on a vehicle body-side end portion of the checker arm 300 is in contact with the vehicle body mounting part 200, the door 30 is opened to the maximum opening angle thereof and is prevented from opening any further.

During the process in which the door 30 is opened from the closed state shown in FIG. 3 to the opened state at the maximum opening angle shown in FIG. 4, the checker arm 300 is coupled to the locking latch 400. As shown in FIG. 4, when the door 30 is opened to the maximum opening angle, a user may operate a lever to allow the checker arm 300 to be decoupled from the locking latch 400, and as shown in FIG. 5, the checker arm 300 is decoupled from the locking latch 400, thereby allowing the door 30 to be opened further.

For the sake of understanding, the explanation assumes that a user operates the lever when the door 30 is in the opened state at the maximum opening angle. However, a user may also operate the lever before the door 30 reaches the maximum opening angle, thereby allowing the checker arm 300 to be decoupled from the locking latch 400. That is, as will be described later, the locking latch 400 according to an embodiment of the present disclosure is moved between the latch position and the release position through sliding movement caused by the lever operation, and this movement may be independent of the opening angle of the door, allowing a user to decouple the checker arm 300 from the locking latch 400 at any time by operating the lever.

In addition, in FIG. 5, although the locking latch 400 is decoupled from the checker arm 300, the door 30 is pivotably coupled to the vehicle body 20 by one or more hinges (not shown). The door 30 is opened by pivoting relative to the vehicle body 20 along a predetermined movement path defined by the hinges.

Hereinafter, on the basis of the above-described door closing/opening mechanism, the door checker assembly 10 for a vehicle according to an embodiment of the present disclosure will be described in more detail.

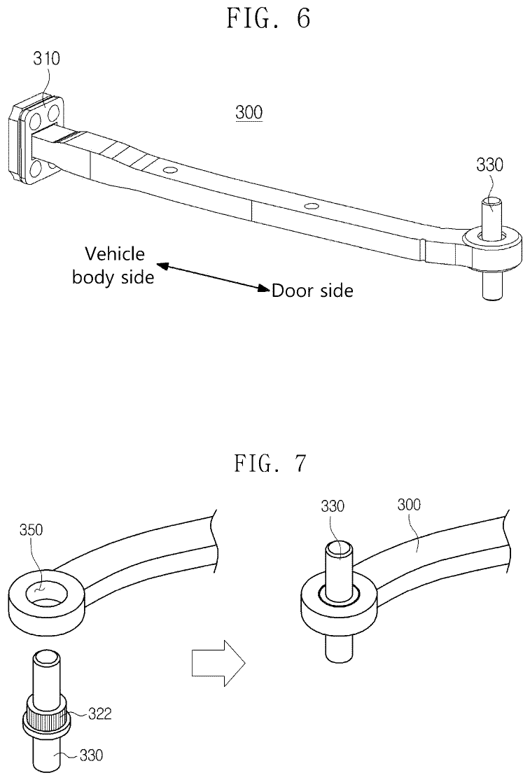

FIG. 6 illustrates a checker arm according to an embodiment of the present disclosure, and FIG. 7 is a view illustrating the coupling of the checker arm and a pin according to an embodiment of the present disclosure.

As illustrated in FIG. 6, according to an embodiment of the present disclosure, the stopper 310 is installed on the vehicle body-side end portion of the checker arm 300, and a pin 330 is installed on a door-side end portion of the checker arm 300.

In addition, as illustrated in FIG. 7, the pin 330 may be installed by being press-fitted into a through hole 350 formed at the door-side end portion of the checker arm 300. To ensure that the pin 330 is more securely press-fitted into the through hole 350 of the checker arm 300, a serration 332 having a toothed shape may be formed along the outer circumference of a portion of the pin 330 that is coupled to the through hole 350.

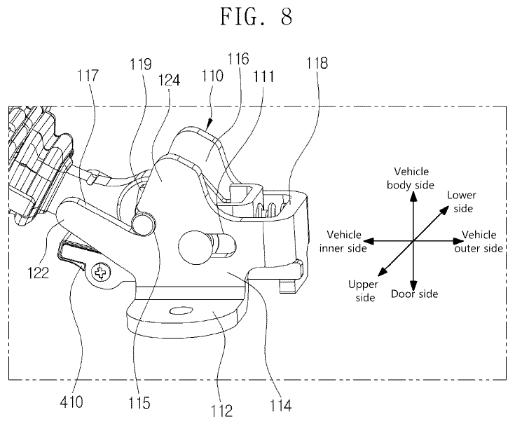

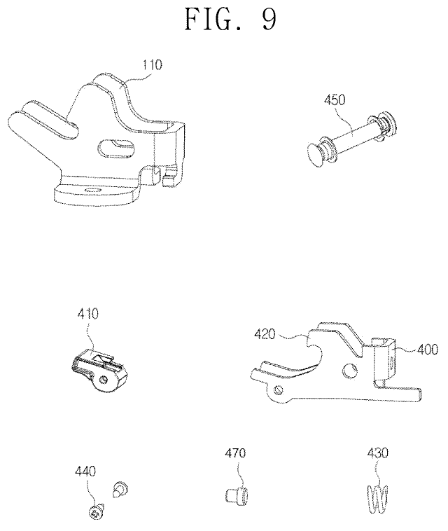

FIG. 8 is a partial perspective view of the door checker assembly for a vehicle according to an embodiment of the present disclosure. FIG. 9 is an exploded perspective view of a housing and components coupled inside the housing in the door checker assembly for a vehicle according to an embodiment of the present disclosure.

As illustrated in FIGS. 8 and 9, according to an embodiment of the present disclosure, the door mounting part 100 may include the housing 110 and components accommodated inside the housing 110.

According to an embodiment of the present disclosure, the housing 110 includes mounting flanges 112 to be mounted to the door 30 and may have at least an opening part for coupling and decoupling the checker arm 300.

For example, the housing 110 may include an upper plate 114, a lower plate 116 spaced apart from and facing the upper plate 114, and a connecting plate 118 that connects the vehicle outward end of the upper plate 114 with the vehicle outward end of the lower plate 116. The mounting flanges 112 are provided on the door-side ends of the upper plate 114 and the lower plate 116, respectively.

The upper plate 114 and the lower plate 116 may respectively include through holes 111 extending in directions from the outside to inside of the vehicle. The through holes 111 may be configured to face each other.

Each of the upper plate 114 and the lower plate 116 may include a housing coupling recess 115 formed in an arc shape so as to surround at least a portion of the outer circumferential surface of the pin 330 of the checker arm 300 when the pin 330 of the checker arm 300 is coupled to the locking latch 400, a first housing protrusion part 122 having a first guide surface 117 extending from a first end of the housing coupling recess 115, and a second housing protrusion part 124 having a second guide surface 119 extending from a second end of the housing coupling recess 115.

For example, the first guide surface 117 may be configured to extend from the first end of the housing coupling recess 115 in the vehicle inward direction and the vehicle body-side direction, and the second guide surface 119 may be configured to extend from the second end of the housing coupling recess 115 in the vehicle outward direction and the vehicle body-side direction.

Through the configurations of the guide surfaces, when the checker arm 300 is decoupled from and then re-coupled to the locking latch 400, the pin 330 of the checker arm 300 may be guided along the first guide surface 117 or the second guide surface 119 into the housing coupling recess 115, thereby reducing the risk of the checker arm 300 failing to be coupled to the locking latch 400.

According to an embodiment of the present disclosure, the locking latch 400 includes a lever 410 installed on a vehicle inward end portion thereof. The lever 410 may, for example, be fixed to the locking latch 400 by a coupling pin 440. In addition, the locking latch 400 includes a protruding part extending upward and a protruding part extending downward. For example, these protruding parts may be implemented by a bar 450 having a predetermined length that is coupled to the through holes of the locking latch 400 and installed to extend in a vertical direction.

The protruding parts extend through the through holes 111 of the housing 110, and as the protruding parts move within the through holes 111, the movement of the locking latch 400 in the vehicle outward or inward direction may be guided, thereby enabling the guided movement of the locking latch 400.

In addition, according to an embodiment of the present disclosure, the door mounting part 100 may include a biasing member 430 that biases the locking latch 400 in one direction so that the locking latch 400 is positioned at the latch position when no external force is applied to the locking latch 400.

For example, the biasing member 430 may be a coil spring and may be installed inside the housing 110. A first end of the coil spring may be arranged to be in contact with the inner surface of the housing 110, and a second end of the coil spring may be arranged to be in contact with the outer surface of the locking latch 400. A position determination part 470 may be coupled to the housing 110 to keep the coil spring in place, and at least a portion of the position determination part 470 may be positioned inside the coil spring.

According to an embodiment of the present disclosure, when the locking latch 400 is located at the latch position, the locking latch 400 may include a latch protrusion part 420 configured to cooperate with the housing coupling recess 115 of the housing 110 to restrain the pin 330 of the checker arm 300.

For example, the latch protrusion part 420 may include a holding part 422 extending in the door-side direction so that the holding part 422 restrains the pin 330 of the checker arm 300. For example, the pin 330 of the checker arm 300 may move along a predetermined movement path as the door 30 opens, and the holding part 422 may be configured to restrict this movement path to restrain the pin 330 of the checker arm 300.

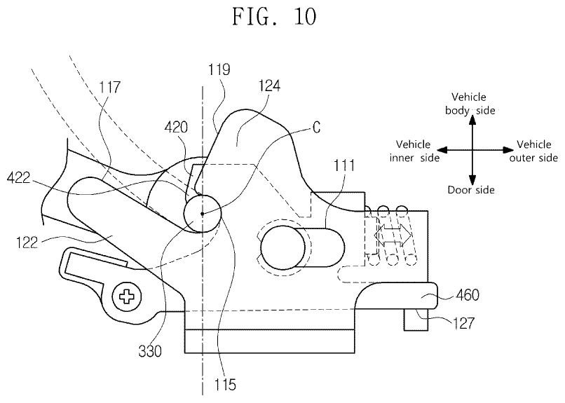

FIG. 10 illustrates a state in which the pin of the checker arm is coupled to a locking latch according to an embodiment of the present disclosure. FIG. 11 illustrates a state in which the pin of the checker arm is separable from the locking latch according to an embodiment of the present disclosure.

Hereinafter, with reference to FIGS. 10 and 11, coupling between the locking latch and the checker arm and decoupling therebetween will be described in more detail.

As shown in FIG. 10, the locking latch (more specifically, each of the upper and lower plates) includes a locking latch coupling recess 480 that is formed in an arc shape so as to surround at least a portion of the outer circumferential surface of the pin 330 of the checker arm 300, and a holding part 422 may be formed to be adjacent to the locking latch coupling recess 480.

As illustrated in FIG. 10, in the state in which the pin 330 of the checker arm 300 is coupled to the locking latch 400, the pin 330 of the checker arm 300 is restrained by the holding part 422. For example, the holding part 422, which extends in the door-side direction, is positioned further inside the vehicle than the center (C) of the pin 330, so that the pin 330 of the checker arm 300 may be restrained by the holding part 422.

In addition, as illustrated in FIG. 11, when a user operates the lever 410 to apply an external force to the locking latch 400 in the vehicle outward direction, the locking latch 400 slides in the vehicle outward direction, and accordingly, the holding part 422 also moves in the vehicle outward direction and does not restrain the pin 330 of the checker arm 300. For example, the holding part 422, which extends in the door-side direction, is positioned further outside the vehicle than the center (C) of the pin 330, so that the pin 330 of the checker arm 300 is not restrained by the holding part 422.

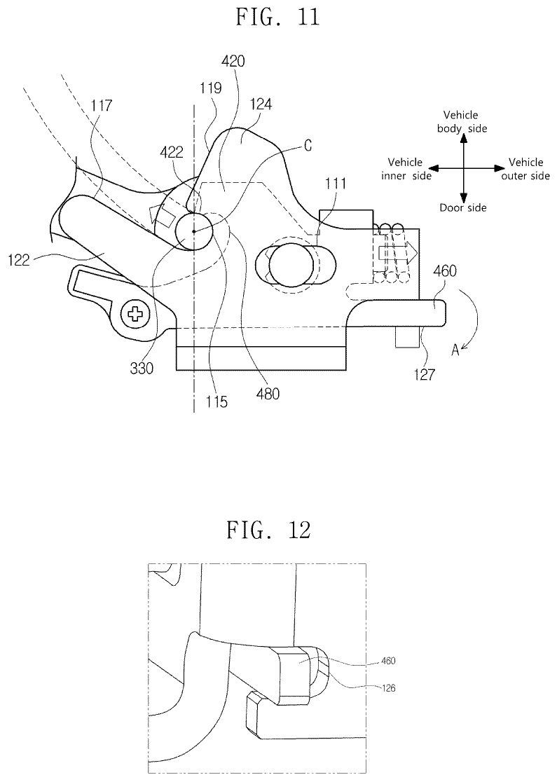

FIG. 12 illustrates a rotational departure prevention structure of the door checker assembly for a vehicle according to an embodiment of the present disclosure.

As illustrated in FIG. 12, the locking latch 400 has the lever 410 formed on a first end thereof, and a bar 460 formed on an end opposite to the end on which the lever 410 is formed. The housing 110 includes a recess 126 that restricts the rotation of the bar 460, so that when the locking latch 400 slides due to an external force applied through the lever 410, the unintended rotation of the locking latch 400 may be prevented.

In particular, it is preferable that the recess 126 is formed to continuously engage with a coupling surface 127 of the bar 460 that faces in the vehicle body-side direction during the movement of the bar 460. This is because the unintended rotation of the locking latch during sliding movement tends to occur in the direction of arrow (A) shown in FIG. 11.

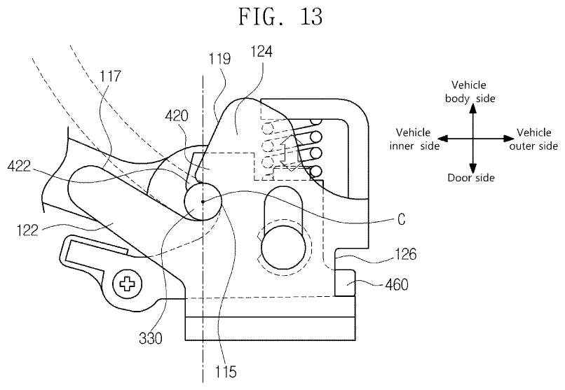

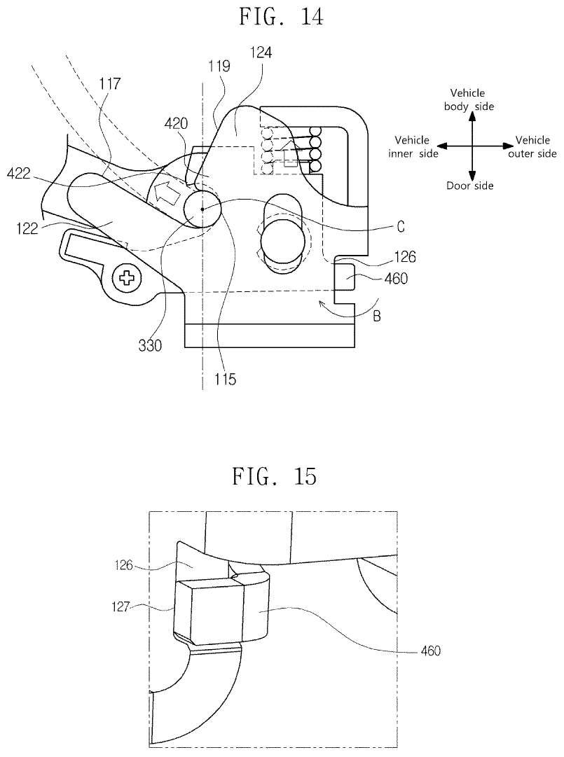

FIG. 13 illustrates a state in which the pin of the checker arm is coupled to the locking latch in the door checker assembly for a vehicle according to another embodiment of the present disclosure. FIG. 14 illustrates a state in which the pin of the checker arm is separable from the locking latch in the door checker assembly for a vehicle according to another embodiment of the present disclosure.

The door checker assembly for a vehicle according to the embodiment shown in FIGS. 13 and 14 differs from the door checker assembly for a vehicle according to the embodiment shown in FIGS. 10 and 11 in that the sliding movement direction of the locking latch is the door-side direction or the vehicle body-side direction.

That is, as illustrated in FIG. 13, in a state where the pin 330 of the checker arm 300 is coupled by the locking latch 400, the pin 330 of the checker arm 300 is restrained by the holding part 422. For example, the holding part 422, which extends in the door-side direction, may be positioned further inside the vehicle than the center (C) of the pin 330, so that the pin 330 of the checker arm 300 may be restrained by the holding part 422.

In addition, as illustrated in FIG. 14, when a user applies an external force to the locking latch 400 in the vehicle body-side direction by operating the lever 410, the locking latch 400 slides in the vehicle body-side direction. Accordingly, the holding part 422 also moves in the vehicle body-side direction, and thus does not restrain the pin 330 of the checker arm 300.

FIG. 15 illustrates a rotational departure prevention structure of the door checker assembly for a vehicle according to another embodiment of the present disclosure.

As illustrated in FIG. 15, the locking latch 400 includes the lever 410 formed on the first end thereof and the bar 460 formed on an end opposite to the end on which the lever 410 is formed, and the housing 110 includes the recess 126 that restricts the rotation of the bar 460, so that when the locking latch 400 slides due to an external force applied through the lever 410, the unintended rotation of the locking latch 400 may be prevented.

In particular, it is preferable that the recess 126 is formed to continuously engage with the coupling surface 127 of the bar 460 that faces in the vehicle outward direction during the movement of the bar 460. This is because, (when a user operates the lever to apply an external force to the locking latch 400 in the vehicle body-side direction as described above), the unintended rotation of the locking latch 400 is likely to occur in the direction of arrow (B) shown in FIG. 14 during the sliding movement of the locking latch 400.

Although the preferred embodiments of the present disclosure have been described above, the present disclosure is not limited to the embodiments described above, and includes all changes that can be easily modified and deemed equivalent by those skilled in the art to which the present disclosure pertains from the embodiments of the present disclosure.

1-14. (canceled)

15. A door checker assembly for a vehicle, the assembly comprising:
a vehicle body mounting part configured to be mounted on a vehicle body of the vehicle;
a door mounting part configured to be mounted on a door of the vehicle;
a checker arm configured to pass through the vehicle body mounting part and be movable relative to the vehicle body mounting part; and
a locking latch mounted on the door mounting part to be slidably movable between a latch position at which the locking latch is coupled to the checker arm and a release position at which the locking latch is decoupled from the checker arm.

16. The assembly of claim 15, wherein the checker arm comprises a pin on a door-side end portion thereof;
wherein, based on the locking latch being located at the latch position, a latch protrusion part of the locking latch is configured to restrain the pin of the checker arm so that the pin of the checker arm is coupled to the locking latch; and
wherein, based on the locking latch being located at the release position, the latch protrusion part of the locking latch is configured not to restrain the pin of the checker arm so that the pin of the checker arm is decoupled from the locking latch.

17. The assembly of claim 16, wherein the latch protrusion part of the locking latch comprises a holding part extending in a door-side direction,
wherein the holding part is configured to restrain the pin of the checker arm so that the pin of the checker arm is coupled to the locking latch.

18. The assembly of claim 17, wherein the holding part moves in a vehicle inward direction and a vehicle outward direction between the latch position and the release position so that, based on the locking latch being located at the latch position, the holding part is arranged further inside the vehicle than a center of the pin of the checker arm; and
wherein, based on the locking latch being located at the release position, the holding part is arranged further outside the vehicle than the center of the pin of the checker arm.

19. The assembly of claim 17, wherein the holding part moves in the door-side direction and a vehicle body-side direction between the latch position and the release position,
so that the holding part is arranged closer to a vehicle body-side when the locking latch is located at the release position than when the locking latch is located at the latch position.

20. The assembly of claim 15, wherein the door mounting part comprises:
a housing configured to at least partially surround the locking latch; and
a biasing member disposed inside the housing and configured to bias the locking latch in one direction so that the locking latch is located at the latch position based on the locking latch not being subjected to any external force.

21. The assembly of claim 20, wherein the biasing member is a coil spring that is arranged such that a first end of the coil spring is in contact with an inner surface of the housing and a second end of the coil spring is in contact with an outer surface of the locking latch.

22. The assembly of claim 20, wherein the housing comprises through holes extending in the same direction as a sliding movement direction of the locking latch,
wherein the locking latch comprises protruding parts configured to extend through the through holes; and
wherein, based on the locking latch moving slidably between the latch position and the release position, movements of the protruding parts in the through holes are guided, so that the movement of the locking latch is guided.

23. The assembly of claim 20, wherein the housing comprises housing coupling recesses formed in arc shapes so that each of the housing coupling recesses surrounds at least a portion of an outer circumferential surface of a pin of the checker arm;
wherein the housing comprises, for each housing coupling recess, a first housing protrusion part having a first guide surface extending from a first end of the housing coupling recess, and a second housing protrusion part having a second guide surface extending from a second end of the housing coupling recess; and
wherein, based on the checker arm being decoupled from and then recoupled to the locking latch, the pin of the checker arm is guided into the housing coupling recess along the first guide surface or the second guide surface.

24. The assembly of claim 23, wherein each first guide surface is configured to extend from the first end of the housing coupling recess in a vehicle inward direction and a vehicle body-side direction.

25. The assembly of claim 23, wherein each second guide surface is configured to extend from the second end of the housing coupling recess in a vehicle outward direction and a vehicle body-side direction.

26. The assembly of claim 20, wherein the locking latch has a lever formed on a first end thereof and a bar formed on an second end opposite to the first end; and
wherein the housing has a recess that restricts a rotation of the bar so that an unintended rotation of the locking latch is prevented when the locking latch slides due to an external force applied through the lever.

27. The assembly of claim 26, wherein the recess is formed to continuously engage with a coupling surface of the bar that faces in a vehicle body-side direction during movement of the bar.

28. The assembly of claim 26, wherein the recess is formed to continuously engage with a coupling surface of the bar that faces in a vehicle outward direction during movement of the bar.

29. A vehicle comprising:
a vehicle body;
a vehicle door;
a vehicle body mounting part mounted on the vehicle body;
a door mounting part mounted on the vehicle door;
a checker arm passing through the vehicle body mounting part and being movable relative to the vehicle body mounting part; and
a locking latch mounted on the door mounting part to be slidably movable between a latch position at which the locking latch is coupled to the checker arm and a release position at which the locking latch is decoupled from the checker arm.

30. The vehicle of claim 29, wherein the checker arm comprises a pin on a door-side end portion thereof.

31. The vehicle of claim 30, wherein, based on the locking latch being located at the latch position, a latch protrusion part of the locking latch is configured to restrain the pin of the checker arm so that the pin of the checker arm is coupled to the locking latch; and
wherein, based on the locking latch being located at the release position, the latch protrusion part of the locking latch is configured not to restrain the pin of the checker arm so that the pin of the checker arm is decoupled from the locking latch.

32. A vehicle comprising:
a vehicle body;
a vehicle door;
a vehicle body mounting part mounted on the vehicle body;
a door mounting part mounted on the vehicle door, the door mounting part comprising a housing and a biasing member disposed inside the housing;
a checker arm passing through the vehicle body mounting part and being movable relative to the vehicle body mounting part; and
a locking latch mounted on the door mounting part to be slidably movable between a latch position at which the locking latch is coupled to the checker arm and a release position at which the locking latch is decoupled from the checker arm, wherein the housing of the door mounting part at least partially surrounds the locking latch and wherein the biasing member is configured to bias the locking latch in one direction so that the locking latch is located at the latch position based on the locking latch not being subjected to an external force.

33. The vehicle of claim 32, wherein the biasing member is a coil spring that is arranged such that a first end of the coil spring is in contact with an inner surface of the housing and a second end of the coil spring is in contact with an outer surface of the locking latch.

34. The vehicle of claim 32, wherein the housing of the door mounting part comprises housing coupling recesses formed in arc shapes so that each of the housing coupling recesses surrounds at least a portion of an outer circumferential surface of a pin of the checker arm.
